(19) United States
(12) Patent Application Publication
(10) Pub. No.: US 2015/0170133 A1
(43) Pub. Date: Jun. 18, 2015

(54) SYSTEM, APPARATUS AND METHOD FOR PROXIMITY RECOGNITION AND TRANSFER

(71) Applicant: MOZIDO, INC., Austin, TX (US)

(72) Inventors: Mike Love, Austin, TX (US); Teri Harwood, Austin, TX (US); Steve Bacastow, Cumming, GA (US)

(21) Appl. No.: 14/571,991

(22) Filed: Dec. 16, 2014

Related U.S. Application Data
(60) Provisional application No. 61/917,750, filed on Dec. 18, 2013.
(60) Provisional application No. 62/014,438, filed on Jun. 19, 2014.

(51) Int. Cl. G06Q 20/32

(52) U.S. Cl. CPC G06Q 20/3224; G06Q 20/3278; G06Q 20/3226

(57) ABSTRACT

A system, method and apparatus for the identification of users and devices based on proximity. More specifically, embodiments of the present invention relate to identifying registered devices and users using a combination of components, factors and technologies including geo location, sound, and low energy Bluetooth. Further embodiments include the transacting of payments between registered users that are within a specified proximity of each other.

### RELATED APPLICATIONS

This application claims priority to and the benefit of U.S. Provisional Application No. 61/917,750, entitled “System, Apparatus and Method for Proximity Recognition and Payment” filed on Dec. 18, 2013, and further claims priority to and the benefit of U.S. Provisional Application No. 62/014,438, entitled “System, Apparatus and Method for Proximity Recognition and Payment” filed on Jun. 19, 2014, each of which of is incorporated by reference herein in its entirety.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

Embodiments of the present invention relates to a system, method and apparatus for the identification of users and devices based on proximity using a combination of components, factors and technologies including geo location, sound, and low energy Bluetooth.

### BACKGROUND OF THE INVENTION

There has been a significant increase in the use of mobile devices for payment transactions. These payment transactions may be person-to-person, person-to-business, or business-to-business. In some cases, payment transactions may be completed between well-known parties such as friends or relatives, while in other cases, payments are performed between parties that are not well known such as between users and service providers (e.g. waiter, waitress, bell hop, taxi driver, etc.). In some cases, the service providers may also be merchants and may have the capability to accept payments under a Merchant ID and POS device. However, in other cases, these service providers may not be classified as merchants and may lack the ability to accept a non-cash payment or tip. Location-based services may be used to locate and identify nearby participants for the purpose of creating a one-time payment in exchange for services. However, location based services are not always available due to wireless coverage limitations. Moreover, the ability to accurately calculate the distance between individuals using cloud, or remote geo location services is unreliable.

### BRIEF SUMMARY

Embodiments described herein provide methods and systems that allow participating consumers and businesses to initiate and fulfill payment transactions using mobile devices based on their physical proximity to one another.

In one embodiment, the systems described herein allow a participant to identify a payee or payer in a transaction using peer-to-peer communication between heterogeneous mobile devices.

In another embodiment, mobile device users can implement the methods and systems described herein to register their mobile devices, their identities and their geo locations (or “geo location” herein) with a cloud-based system, and can use a form of low energy Bluetooth (BLE) or other wireless communication means to detect other nearby registered mobile devices.

In another embodiment, mobile device users can register their mobile devices, their identities and their geo locations with a cloud-based system and can use a pre-determined sound to detect other nearby registered mobile devices. A first registered mobile device can receive a sound wave from a central server and transmit the received sound wave using a speaker. A second registered mobile device can record the sound wave using a microphone and transmit the recorded sound wave to the central server. The central server can record the sound wave received from the second mobile device as an indicator of the location of the second mobile device and its proximity to the first mobile device. The first mobile device can then request the identity of the user of the second mobile device.

In another embodiment, mobile device users can register their mobile devices, their identities and their geo locations with a cloud-based system and can use a background noise to detect other nearby registered mobile devices. A first registered mobile device can listen to background noise using a microphone and transmit the background noise to a central server. The central server can record this background noise as an indicator of the location of the first mobile device. A second registered mobile device can listen to background noise using a microphone and transmit the background noise to a central server. The central server can record this background noise as an indicator of the location of the second mobile device. The first mobile device can request a list of nearby registered mobile devices from the remote server. The remote server can use the recorded background noise from the second mobile device to determine its proximity to the first mobile device and send a message the first mobile device that includes the location and identity of the user of the second mobile device.

Embodiments described herein may thus provide systems and methods for peer-to-peer communication between heterogeneous devices. Embodiments described herein may be used independently or may be combined together.

In one embodiment, a computer system identifies mobile devices within a specified proximity. The computer system receives from a first registered mobile device a proximity device request message. The proximity device request message includes a data structure that itself includes information requesting identification of mobile devices within a specified range of the first mobile device. The computer system determines that a second registered mobile device is currently in a location that falls within the specified range of the first mobile device and further receives from the first mobile device a payment transaction initiation request requesting that money be transferred from the first mobile device to the second mobile device. The payment transaction initiation request includes a data structure that itself includes at least one identifier corresponding to the first mobile device and a transfer amount. The computer system further processes the money transfer according to the payment transaction initiation request such that the transfer amount is transferred from the first mobile device to the second mobile device, and sends a receipt to the first mobile device indicating that the transfer amount was transferred to the second mobile device. As each user's payment account information is not actually transferred between users, and is instead only transferred to the computer system 1201, security of the payment process is increased. Moreover, as this payment account data is not transferred between the user's mobile devices, wireless network bandwidth is conserved during the payment process.

In another embodiment, a computer system conducts a transaction between registered users that are within a specified proximity of each other. The computer system receives from a second mobile device an identity request requesting the identity of a first registered user, where the first registered user has an associated payment account, and where the identity request includes an identifier of a first mobile device associated with the first registered user. Upon determining that the first mobile device is within an established proximity radius, the computer system provides identity information associated with the first registered user to the second mobile device. The computer system also receives from the first mobile device an identity request requesting the identity of the second registered user, where the second registered user has an associated payment account, and where the identity request includes an identifier of the second mobile device associated with the second registered user. Upon determining that the second mobile device is within an established proximity radius, the computer system provides at least a portion of identity information associated with the second registered user to the first mobile device. The computer system then receives a payment request including the first mobile device's identifier, the second mobile device's identifier, a payment amount and a perishable token associated with the payment request, and upon updating the first registered user's payment account to reflect an amount debited from the first registered user's payment account and upon updating the second registered user's payment account to reflect an amount credited to the second registered user's payment account, sends a payment receipt to the first mobile device and to the second mobile device indicating that the requested payment was processed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 shows a variety of components that may be used for proximity identification using a mobile device.

FIG. 2 shows a sequence of steps performed using iOS mobile devices to identify nearby registered participants using iOS devices.

FIG. 3 shows a sequence of steps performed using iOS mobile devices to identify nearby registered participants using Android devices.

FIG. 4 shows a sequence of steps performed using Android mobile devices to identify nearby registered participants using iOS devices.

FIG. 5 shows a sequence of steps performed using a mobile device to transmit noise signals for identification purposes.

FIG. 6 shows a sequence of steps performed using a mobile device to record noise signals for identification purposes.

FIG. 7 shows a sequence of steps performed using background noise recorded by a sender's mobile devices to identify nearby registered participants.

FIG. 8 shows a sequence of steps performed using an iOS device to identify other nearby devices using BLE and a remote database.

FIG. 9 shows a sequence of steps performed using an Android device to identify other nearby devices using BLE and a remote database.

FIG. 10 shows a sequence of steps performed using a mobile device to detect a nearby user based on social media factors while using BLE.

FIG. 11 shows a sequence of steps performed using BLE for payments between registered users.

FIG. 12 illustrates a computing environment in which embodiments described herein may operate including identifying mobile devices within a specified proximity and conducting a transaction between registered users that are within a specified proximity of each other.

FIG. 13 illustrates a flowchart of an example method for identifying mobile devices within a specified proximity.

FIG. 14 illustrates a flowchart of an example method for conducting a transaction between registered users that are within a specified proximity of each other.

FIG. 15 illustrates multiple users with mobile devices that are within and outside of an established proximity radius.

FIG. 16 illustrates an embodiment in which background noise is used to determine whether two mobile devices are within proximity of each other.

### DETAILED DESCRIPTION OF THE INVENTION

The following discussion refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

As implemented herein, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

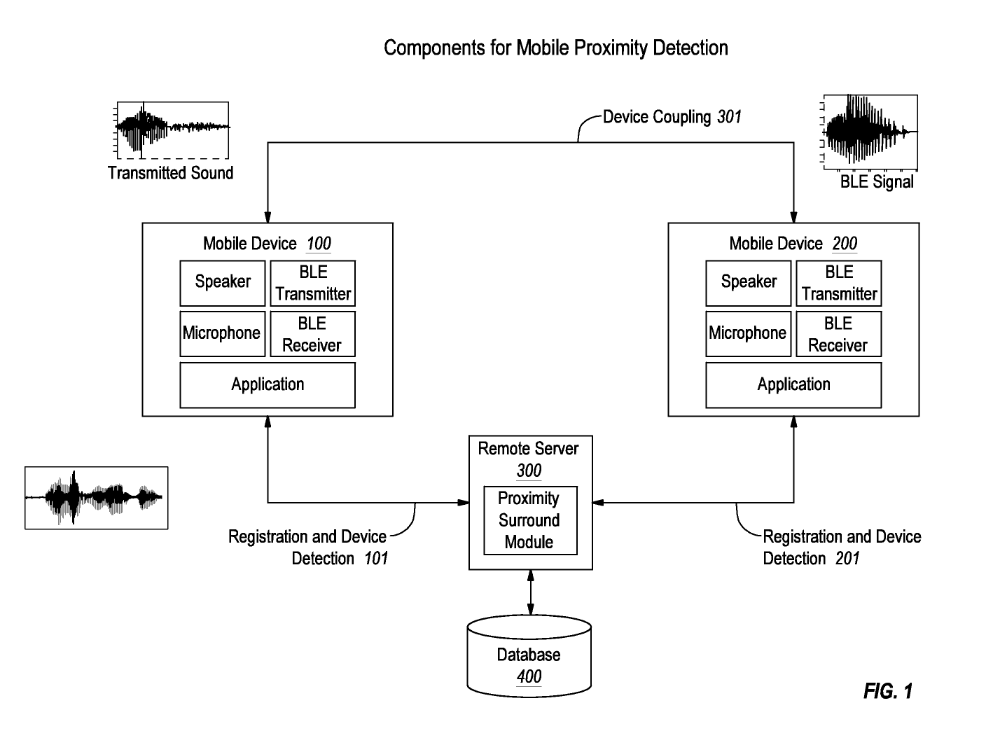

As shown in FIG. 1, there are several components that are required in order to facilitate the methods described herein. Mobile Device (100) comprises an application, speaker, microphone, BLE transmitter, and BLE receiver. Mobile Device (200) comprises an application, speaker, microphone, BLE transmitter, and BLE receiver. Remote Server (300) comprises a Proximity Surround Module which is operable to receive registration information from each mobile device, store registration information into database (400) and to send a list of registered users and devices to each mobile device as illustrated using lines (101) and (201). As shown in line (301), the mobile devices may be coupled using one or more of transmitted sound wave (500) and a BLE signal (600). Environmental sound (700) may be used by the system to identify a specific location.

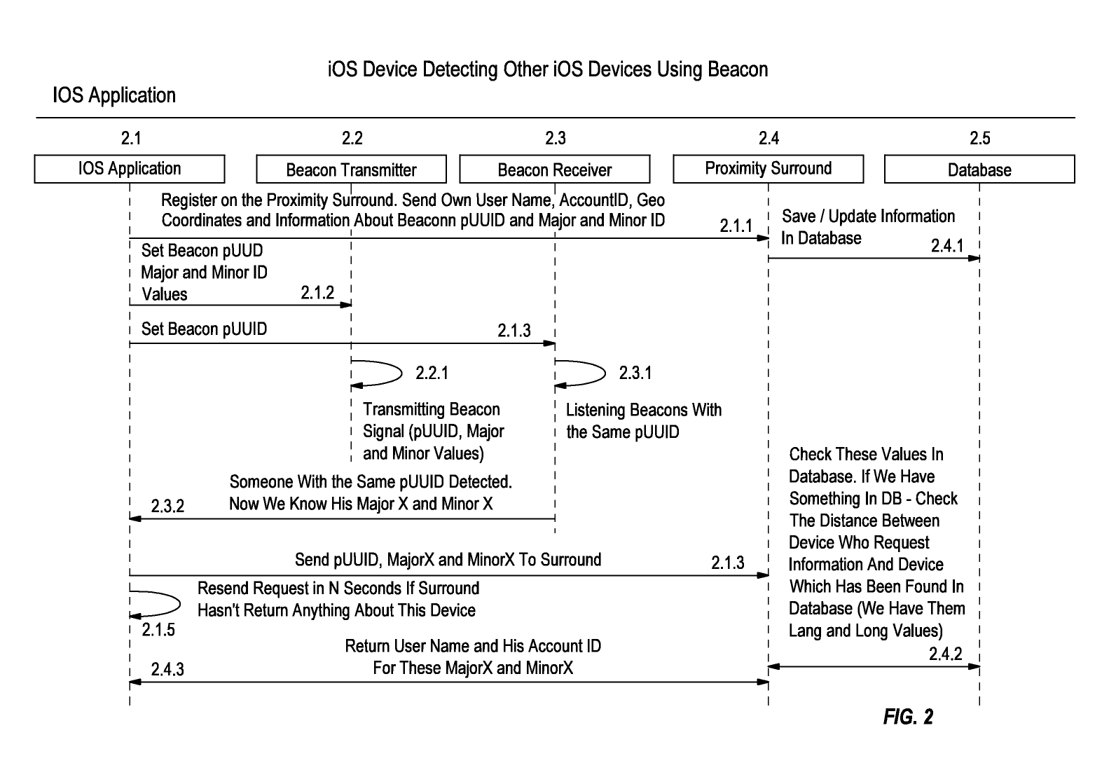

As shown in FIG. 2, iOS eco-system components are comprised of an iOS application (2.1), iBeacon Transmitter (2.2), iBeacon Receiver (2.3), Proximity Surround Module (2.4), and Database (2.5). iOS application (2.1) registers on the Proximity Surround Module (2.4) shown using line (2.1.1). Registration data can include but is not limited to user name, account ID, geo coordinates, iBeacon pUUID, and major and minor IDs are stored by the Proximity Surround Module (2.4) onto Database (2.5). Geo coordinates may be exact latitude and longitude coordinates if available or geo coordinates may be an approximation of latitude and longitude coordinates. After the registration step is complete, the iBeacon Transmitter (2.2) is configured with the iBeacon pUUD and major and minor ID values as shown in line (2.1.2). Concurrently, the iBeacon Receiver (2.3) is configured using the iBeacon pUUID as shown in line (2.1.3). Step (2.2.1) illustrates the ongoing transmission of the iBeacon signal comprised of the pUUID and major and minor values. Step (2.3.1) illustrates the ongoing process of listening for iBeacons with the same pUUID. Line (2.3.2) illustrates the detection of another device with the same pUUID and the related major x and minor x values. The detected pUUID and major x and minor x values are transmitted to the Proximity Surround Module (2.4) as shown in line (2.1.3). This process is continued based on an established interval as shown in Step (2.1.5). After each transmission of data to the Proximity Surround Module (2.2), the Proximity Surround checks the Database (2.5) to determine if a device with matching major x and minor x values has been registered. If a device with matching values is detected, the Proximity Surround Module (2.4) returns the user name(s) and account ID(s) to the iOS application as shown in line (2.4.3). A payment transaction may be initiated using the mobile device (2.1) to select the Payee from the list of users returned.

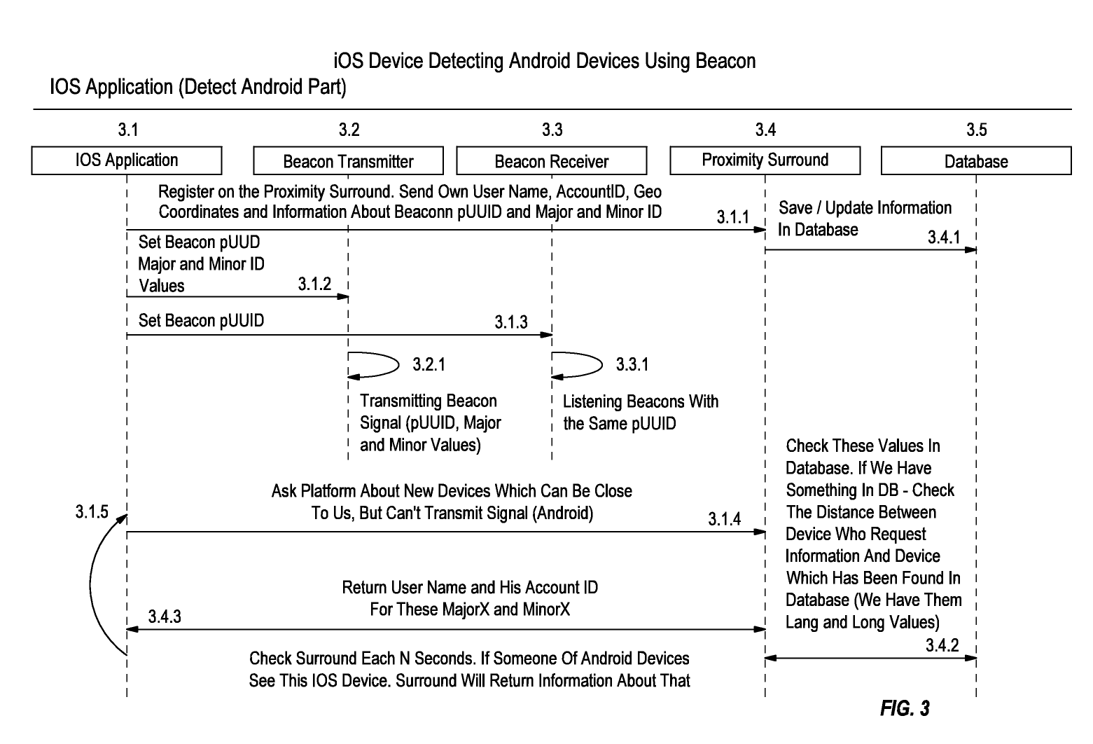

As shown in FIG. 3, iOS eco-system components are comprised of an iOS application (3.1), iBeacon Transmitter (3.2), iBeacon Receiver (3.3), Proximity Surround Module (3.4), and Database (3.5). iOS application (3.1) registers on the Proximity Surround Module (3.4) shown using line (3.1.1). Registration data can include but is not limited to user name, account ID, geo coordinates, iBeacon pUUID, and major and minor IDs are stored by the Proximity Surround Module (3.4) onto Database (3.5). Geo coordinates may be exact latitude and longitude coordinates if available or geo coordinates may be an approximation of latitude and longitude coordinates. After the registration step is complete, the iBeacon Transmitter (3.2) is configured with the iBeacon pUUD and major and minor ID values as shown in line (3.1.2). Concurrently, the iBeacon Receiver (3.3) is configured using the iBeacon pUUID as shown in line (3.1.3). Step (3.2.1) illustrates the ongoing transmission of the iBeacon signal comprised of the pUUID and major and minor values. Step (3.3.1) illustrates the ongoing process of listening for iBeacons with the same pUUID. However, if an Android device is not operable to transmit pUUID data using iBeacon, the Android device will not be detected by Step (3.3.1). In this scenario, line (3.1.4) illustrates a process whereby the iOS application (3.1) periodically asks the Proximity Surround Module (3.4) if there are any new devices which are close by but cannot transmit the required signal for detection. After each request of ‘invisible devices’ to the Proximity Surround Module (3.4), the Proximity Surround checks the Database (3.5) to determine if a device within established proximity based on latitude and longitude has been registered. If a device with matching values is detected, the Proximity Surround Module (3.4) returns the user name(s) and account ID(s) to the iOS application as shown in line (3.4.3). The above process is repeated based on a timer as shown in Step (3.1.5). A payment transaction may be initiated using the mobile application (3.1) to select the Payee from the list of users returned.

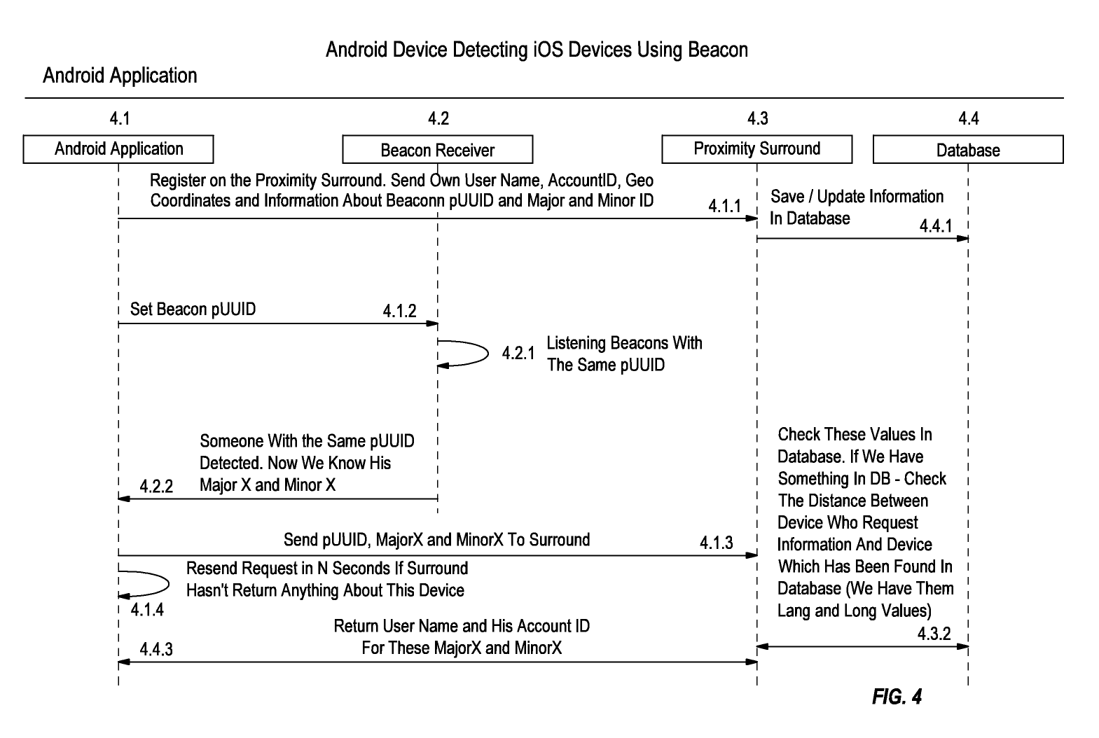

As shown in FIG. 4, Android device eco-system components are comprised of an Android application (4.1), iBeacon Receiver (4.2), Proximity Surround Module (4.3), and Database (4.4). Android application (4.1) registers on the Proximity Surround Module (4.3) shown using line (4.1.1). Registration data can include but is not limited to user name, account ID, geo coordinates, iBeacon pUUID, and major and minor IDs are stored by the Proximity Surround Module (4.3) onto Database (4.4). Geo coordinates may be exact latitude and longitude coordinates if available or geo coordinates may be an approximation of latitude and longitude coordinates. After the registration step is complete, the iBeacon Receiver (4.2) is configured using the iBeacon pUUID as shown in line (4.1.2). Step (4.2.1) illustrates the ongoing of listening for iBeacons with the same pUUID. For purposes of this example, the Android device is fully operable to detect an iOS device comprised of an iBeacon Transmitter such as the iOS device (2.1) previously illustrated in FIG. 2. As such, line (4.2.2) illustrates the detection of another device with the same pUUID and the related major x and minor x values. The detected pUUID and major x and minor x values are transmitted to the Proximity Surround Module (4.3) as shown in line (4.1.3). This process is continued based on an established interval as shown in Step (4.1.4). After each transmission of data to the Proximity Surround Module (4.3), the Proximity Surround checks the Database (4.4) to determine if a device with matching major x and minor x values has been registered. If a device with matching values is detected, the Proximity Surround Module (4.3) returns the user name(s) and account ID(s) to the Android application as shown in line (4.3.3). A payment transaction may be initiated using the mobile device (4.1) to select the Payee from the list of users returned.

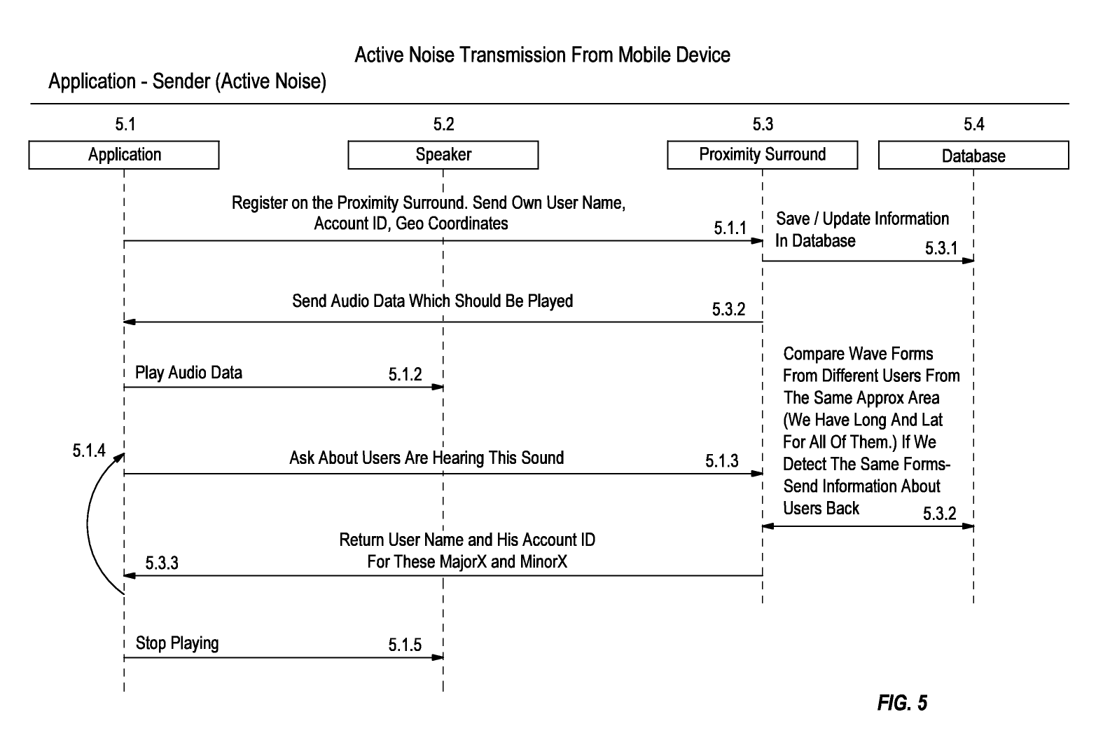

As shown in FIG. 5, mobile device eco-system components are comprised of an application (5.1), speaker (5.2), Proximity Surround Module (5.3), and Database (5.4). Application (5.1) registers on the Proximity Surround Module (5.3) shown using line (5.1.1). Registration data can include but is not limited to user name, account ID, geo coordinates are stored by the Proximity Surround Module (5.3) onto Database (5.4). Geo coordinates may be exact latitude and longitude coordinates if available or geo coordinates may be an approximation of latitude and longitude coordinates. The Proximity Surround Module (5.3) can send a pre-determined audio sound data file to the Mobile Application (5.1) as shown in line (5.3.2). Mobile Application (5.1) can play the received audio sound using Speaker (5.2). [note—not shown here is a second mobile device (7.1) operable to record the sound being transmitted by Application (5.1)]. Now referring to line (5.1.3), after the sound transmission has been initiated, Mobile Application (5.1) asks the Proximity Surround Module (5.3) if there are any nearby users that have recorded the same sound. The Proximity Surround Module (5.3) using process shown in line (5.3.2) checks the Database (5.4) to determine if there are any registered users within a reasonably close proximity that have recorded the same sound. If such a user or users is determined, the Proximity Surround Module (5.3) returns the name and ID of these users to the Application (5.1) as shown in line (5.3.3). This process is repeated until a list of users has been returned as shown in Step (5.1.4). After a satisfactory list of users has been returned to the Application (5.1), the Application terminates the transmission of the audio sound. A payment transaction may be initiated using the mobile device (5.1) to select the Payee from the list of users returned.

It should be noted that the sound which is being transmitted by the mobile device Speaker (5.2) may be of a frequency that it cannot be detected by the human ear. It is thus an advantage of this method to use sound as a basis for detecting mobile devices without the user's awareness of this method.

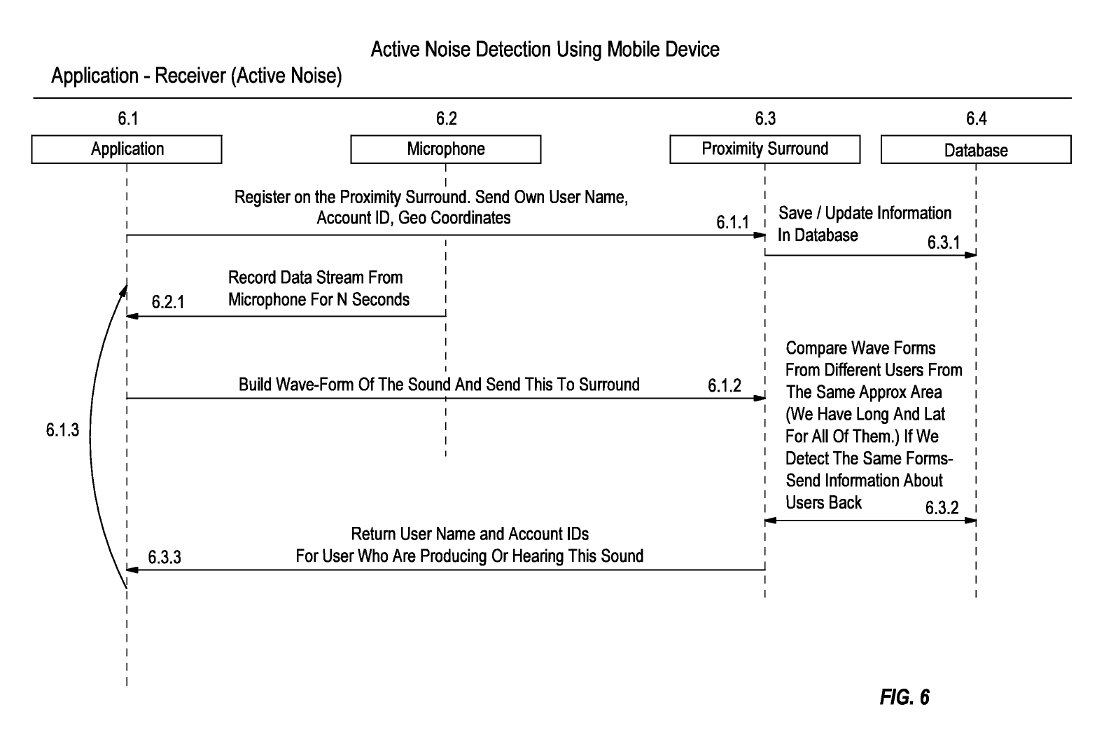

As shown in FIG. 6, mobile device eco-system components are comprised of an application (6.1), microphone (6.2), Proximity Surround Module (6.3), and Database (6.4). Application (6.1) registers on the Proximity Surround Module (6.3) shown using line (6.1.1). Registration data can include but is not limited to user name, account ID, geo coordinates are stored by the Proximity Surround Module (6.3) onto Database (6.4). Geo coordinates may be exact latitude and longitude coordinates if available or geo coordinates may be an approximation of latitude and longitude coordinates. Mobile Application (6.1) can record an audio sound using Speaker (6.2). [note—not shown here is a second mobile device (5.1) operable to transmit the sound being recorded by Application (6.1)]. Now referring to line (6.1.2), after the sound transmission has been recorded, Mobile Application (6.1) sends the recorded sound file to the central server and asks the Proximity Surround Module (6.3) if there are any nearby users that have transmitted the same sound. The Proximity Surround Module (6.3) using process shown in line (6.3.2) checks the Database (6.4) to determine if there are any registered users within a reasonably close proximity that have transmitted the same sound. If such a user or users is determined, the Proximity Surround Module (6.3) returns the name and ID of these users to the Application (6.1) as shown in line (6.3.3). This process is repeated until a list of users has been returned as shown in Step (6.1.4). A payment transaction may be initiated using the mobile device (6.1) to select the Payee from the list of users returned.

It should be noted that the sound which is being recorded by the mobile device Speaker (6.2) may be of a frequency that it cannot be detected by the human ear. It is thus an advantage of this method to use sound as a basis for detecting mobile devices without the user's awareness of this method.

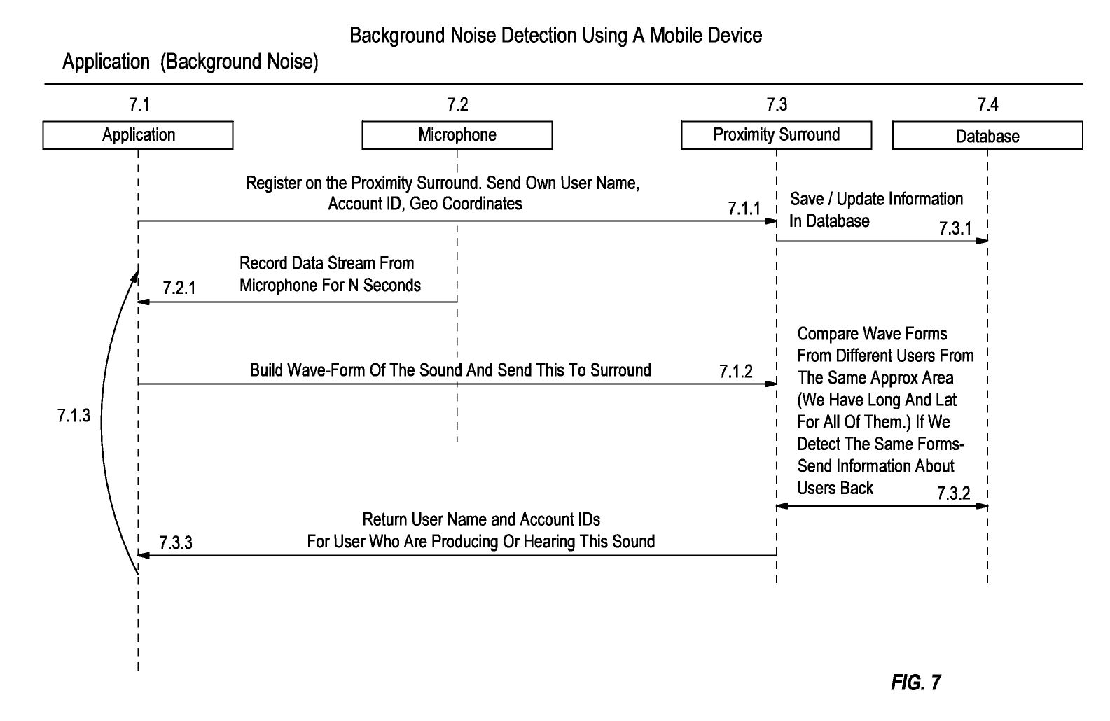

As shown in FIG. 7, mobile device eco-system components are comprised of an application (7.1), microphone (7.2), Proximity Surround Module (7.3), and Database (7.4). Application (7.1) registers on the Proximity Surround Module (7.3) shown using line (7.1.1). Registration data can include but is not limited to user name, account ID, geo coordinates are stored by the Proximity Surround Module (7.3) onto Database (7.4). Geo coordinates may be exact latitude and longitude coordinates if available or geo coordinates may be an approximation of latitude and longitude coordinates. Mobile Application (7.1) can record an audio background sound using Speaker (7.2). [note—not shown here is a second mobile device (5.1) operable to record the same background sound being recorded by Application (7.1)]. Now referring to line (7.1.2), after the sound has been recorded, Mobile Application (7.1) sends the recorded sound file to the central server and asks the Proximity Surround Module (7.3) if there are any nearby users that have transmitted the same sound. The Proximity Surround Module (7.3) using process shown in line (7.3.2) checks the Database (7.4) to determine if there are any registered users within a reasonably close proximity that have transmitted the same sound. If such a user or users is determined, the Proximity Surround Module (7.3) returns the name and ID of these users to the Application (7.1) as shown in line (7.3.3). This process is repeated until a list of users has been returned as shown in Step (7.1.4). A payment transaction may be initiated using the mobile device (7.1) to select the Payee from the list of users returned.

It should be noted that the sound which is being recorded by the mobile device Speaker (7.2) may be of a frequency that it cannot be detected by the human ear. It is thus an advantage of this method to use sound as a basis for detecting mobile devices without the user's awareness of this method.

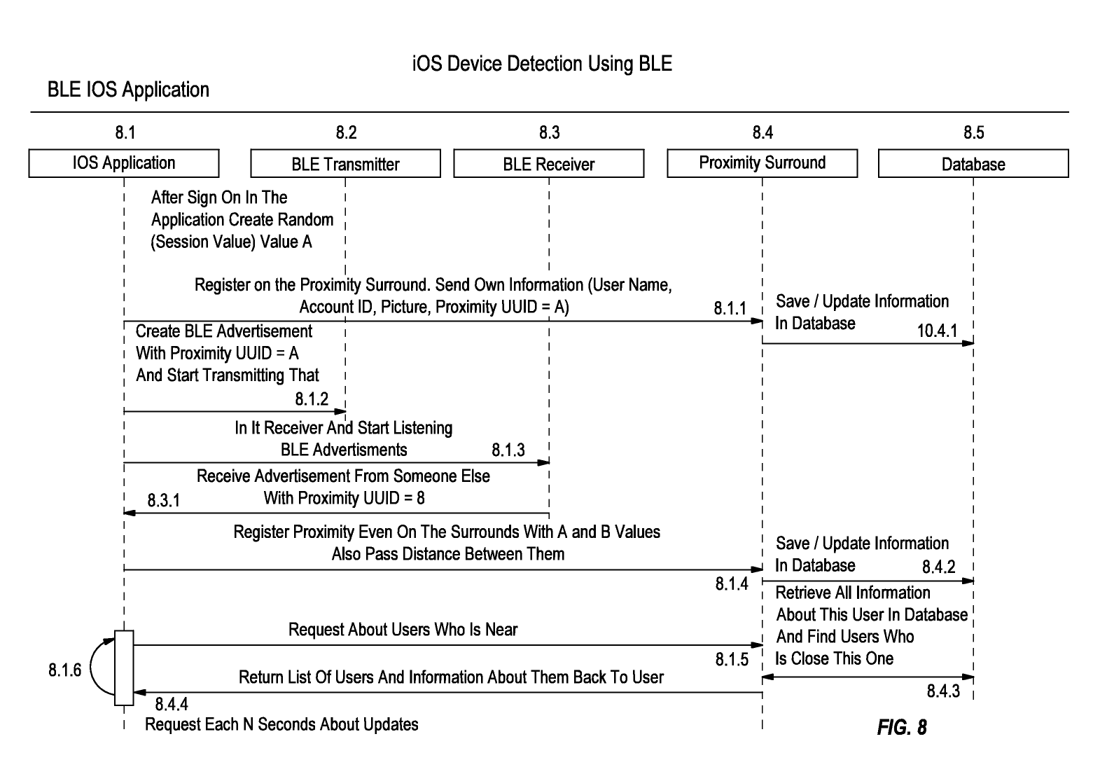

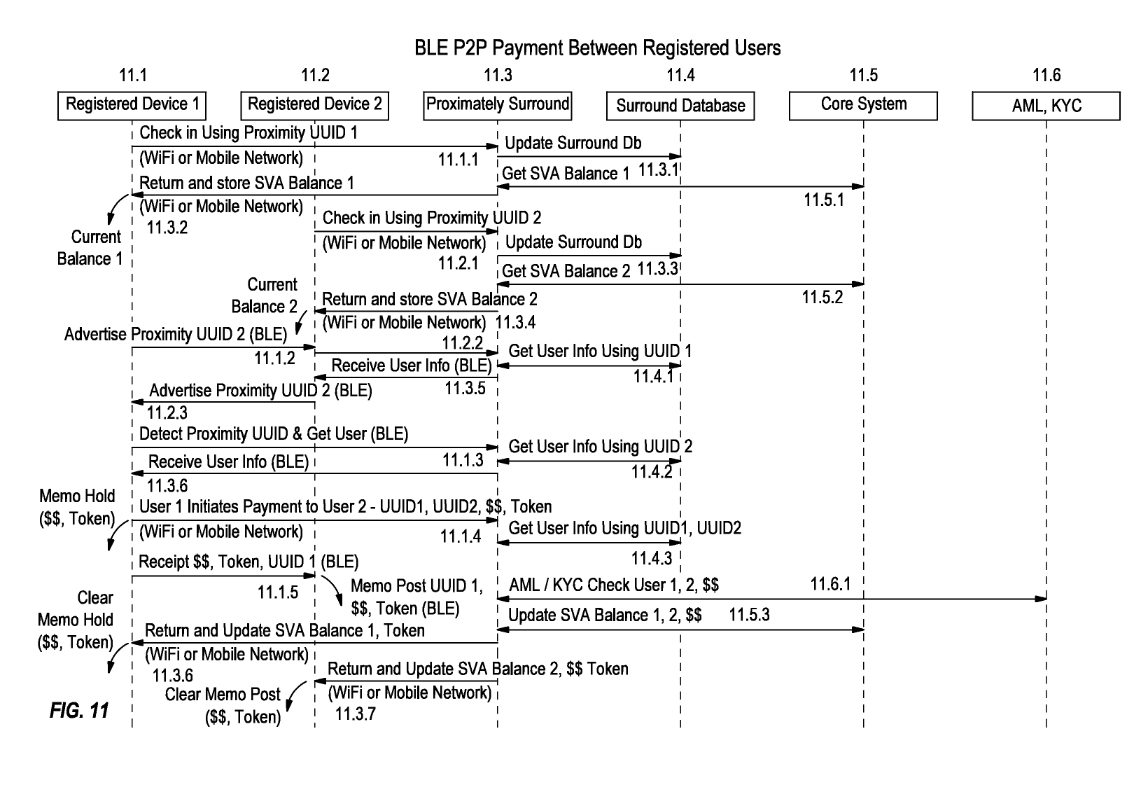

As shown in FIG. 8, iOS eco-system components are comprised of one or more of the following: an iOS application (8.1), BLE Transmitter (8.2), BLE Receiver (8.3), Proximity Surround Module (8.4), and Database (8.5). iOS application (8.1) registers on the Proximity Surround Module (8.4) shown using line (8.1.1). Registration data can include but is not limited to user name, account ID, picture, geo coordinates, proximity UUID value, are stored by the Proximity Surround Module (8.4) onto Database (8.5). Geo coordinates may be exact latitude and longitude coordinates if available or geo coordinates may be an approximation of latitude and longitude coordinates. After the registration step is complete, the BLE Transmitter (8.2) is configured with the BLE UUID value and as shown in line (8.1.2). In connection with this step, the BLE transmitter is operable to transmit the UUID value as an outgoing BLE advertisement. Concurrently, the BLE Receiver (8.3) is initialized to start receiving BLE advertisements as shown in line (8.1.3). Step (8.3.1) illustrates the ongoing process of listening for BLE advertisements with corresponding proximity UUID values. As BLE advertisements are detected, the iOS application (8.1) calculates the distance between devices. iOS application (8.1) registers the corresponding UUID values and distance values onto the Proximity Surround (8.4) as shown in line (8.1.4). As these registration values are received by the Proximity Surround (8.4), the database (8.5) is updated using line (8.4.2). However, if an Android device is not operable to advertise a proximity UUID value using BLE, the Android device will not be detected by Step (8.3.1). In this scenario, line (8.1.5) illustrates a process whereby the iOS application (8.1) periodically asks the Proximity Surround Module (8.4) if there are any new devices which are close by but cannot transmit the required signal for detection. Line (8.4.3) shows the process whereby the Proximity Surround (8.4) checks the Database (8.5) to determine the identity of any detected BLE UUID values as well as any other nearby ‘invisible’ devices. After each request of both visible and ‘invisible devices’ to the Proximity Surround Module (8.4), the Proximity Surround checks the Database (8.5) to determine if a device within established proximity based on latitude and longitude has been registered. If a device with matching values is detected, the Proximity Surround Module (8.4) returns the user name(s) and account ID(s) to the iOS application as shown in line (8.4.4). The above process is repeated based on a timer as shown in Step (8.1.6). A payment transaction may be initiated using the mobile application (8.1) to select the Payee from the list of users returned as further described in FIG. 11.

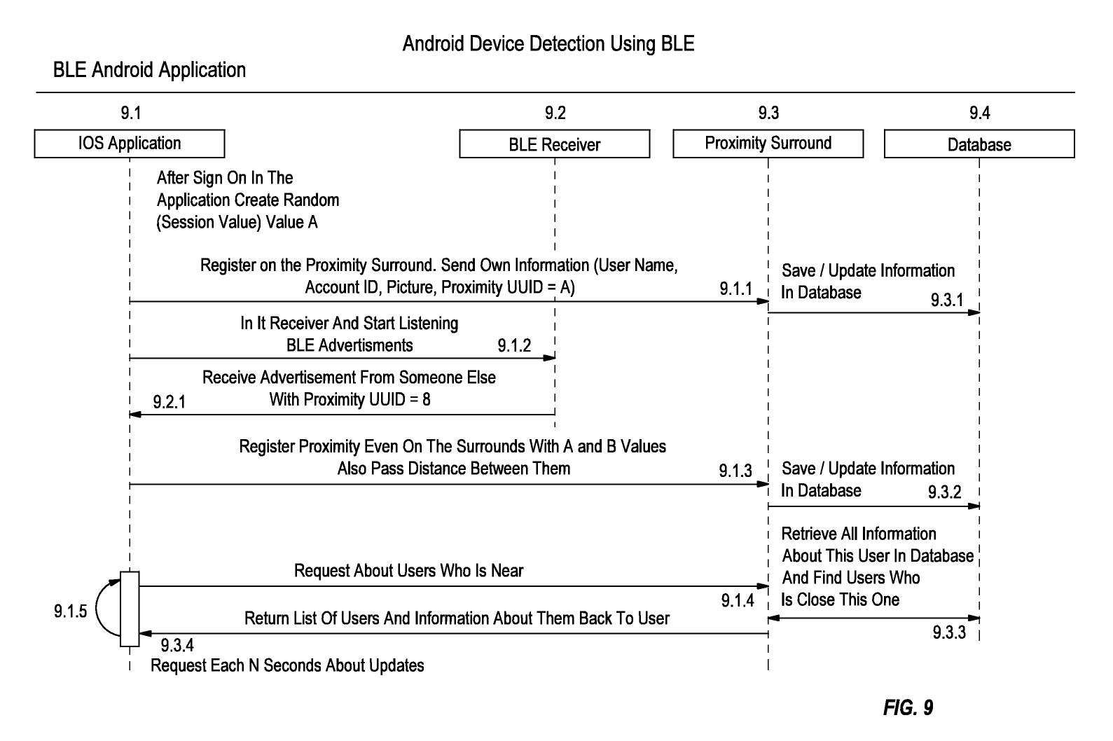

As shown in FIG. 9, Android eco-system components are comprised of an Android application (9.1), BLE Receiver (9.2), Proximity Surround Module (9.3), and Database (9.4). Android application (9.1) registers on the Proximity Surround Module (9.3) shown using line (9.1.1). Registration data can include but is not limited to user name, account ID, picture, geo coordinates, and a proximity UUID value are stored by the Proximity Surround Module (9.3) onto Database (9.4). Geo coordinates may be exact latitude and longitude coordinates if available or geo coordinates may be an approximation of latitude and longitude coordinates. After the registration step is complete, the BLE Receiver (9.2) is initialized as shown in line (9.1.2) at which point it is operable to listen for BLE advertisements. Step (9.2.1) illustrates the ongoing process of listening for BLE advertisements with proximity UUID values. For purposes of this example, the Android device is fully operable to detect an iOS device comprised of an BLE Transmitter such as the iOS device (8.1) previously illustrated in FIG. 8. As BLE advertisements are detected, the Android application (9.1) calculates the distance between devices. The detected UUID and distance values are transmitted to the Proximity Surround Module (9.3) as shown in line (9.1.3). This process is continued based on an established interval as shown in Step (9.1.5). After each transmission of data to the Proximity Surround Module (9.3), the Proximity Surround checks the Database (9.4) to determine if a device with matching UUID values has been registered. If a device with matching values is detected, the Proximity Surround Module (9.3) returns the user name(s) and account ID(s) to the Android application as shown in line (9.3.3). A payment transaction may be initiated using the mobile application (4.1) to select the Payee from the list of users returned as further described in FIG. 11.

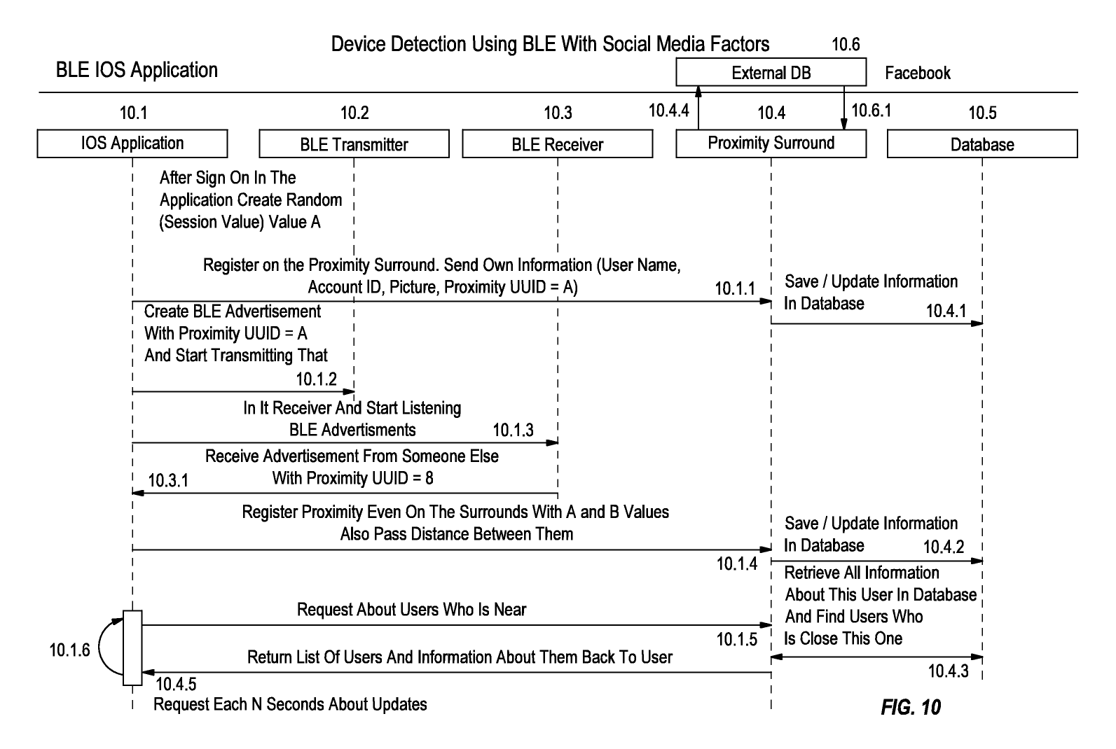

As shown in FIG. 10, iOS eco-system components are comprised of an iOS application (10.1), BLE Transmitter (10.2), BLE Receiver (10.3), Proximity Surround Module (10.4), Database (10.5) and External Database (10.6) as shown maintained at an exemplary entity such as Facebook. iOS application (10.1) registers on the Proximity Surround Module (10.4) shown using line (10.1.1). Registration data can include but is not limited to user name, account ID, picture, geo coordinates, proximity UUID value, are stored by the Proximity Surround Module (10.4) onto Database (10.5). Registration data may also include social media identifiers such as the unique identifiers related to a Facebook or twitter account. If social media identifiers are included with registration data, the Proximity Surround (10.4) can use these credentials to access External database (10.6) as shown in line (10.4.4). As a result of this database query, a list of preferences may be returned to the Proximity Surround (10.4) which are related to the unique registration credentials. These preferences may include a list of current ‘friends’, content from recent postings or ‘likes’, and other information about the registered user such as political party, religious affiliation, sex, marital status, special interests, etc. These preferences are returned to the Proximity Surround (10.4) shown using line (10.6.1) and may be stored in Database (10.5). Geo coordinates may be exact latitude and longitude coordinates if available or geo coordinates may be an approximation of latitude and longitude coordinates. After the registration step is complete, the BLE Transmitter (10.2) is configured with the BLE UUID value and as shown in line (10.1.2). In connection with this step, the BLE transmitter is operable to transmit the UUID value as an outgoing BLE advertisement. Concurrently, the BLE Receiver (10.3) is initialized to start receiving BLE advertisements as shown in line (10.1.3). Step (10.3.1) illustrates the ongoing process of listening for BLE advertisements with corresponding proximity UUID values. As BLE advertisements are detected, the iOS application (10.1) calculates the distance between devices. iOS application (10.1) registers the corresponding UUID values and distance values onto the Proximity Surround (10.4) as shown in line (10.1.4). As these registration values are received by the Proximity Surround (10.4), the database (10.5) is updated using line (10.4.2). Line (10.1.5) illustrates a process whereby the iOS application (10.1) periodically asks the Proximity Surround Module (10.4) if there are any new devices which are close by and where the registered users match pre-registered social media criteria filter such as friend, special interest, or other factor. Line (10.4.3) shows the process whereby the Proximity Surround (10.4) checks the Database (10.5) to determine the identity of any detected BLE UUID values as well as any other social media preferences. After each request to the Proximity Surround Module (10.4), the Proximity Surround checks the Database (10.5) to determine if a device within established proximity based on latitude and longitude and with matching social media attributes has been registered. If a device with matching values is detected, the Proximity Surround Module (10.4) returns the user name(s) and account ID(s) to the iOS application as shown in line (10.4.4). The above process is repeated based on a timer as shown in Step (10.1.6). A transaction may be initiated using the mobile application (10.1) to select a user from the list of users returned. Once selected, the user may be contacted for a variety of purposes including but not limited to making a payment as further described in FIG. 11. For example, if the selected user is identified as a current Facebook friend, the application can send a message to that friend with an invitation to rendezvous. Or, if the selected user is not a Facebook friend but shares mutual interests based on preferences and filters, the application can send a message with an invitation to meet.

FIG. 11 describes a process for using BLE as a basis for making a P2P payment between registered users of a payment service. Components include a first registered mobile device (11.1) comprised of a mobile payment application and a secure database, BLE antenna and BLE transmitter; a second registered mobile device (11.2) comprised of a mobile payment application and a secure database, BLE antenna and BLE transmitter; proximity surround system (11.3); surround Database (11.4); core system (11.5); and AML-KYC system (11.6). The first mobile payment application registers with the proximity surround (11.3) using proximity UUID1 value and other registration data such as user name, account ID, picture, geo coordinates. The proximity surround (11.3) updates the surround database (11.4) with the proximity UUID1 value and other registration data. As shown in line (11.3.1) the proximity surround can then access the core system (11.5) to determine if the registered user has an associated stored value account (SVA). If the registered user has an associated SVA, the proximity surround can return the balance of the SVA to the mobile payment application comprised within registered the first registered mobile device (11.1). The mobile payment application within the first registered mobile device can securely store the SVA balance on the first mobile device (11.1) as shown in line (11.3.2). A secure storage method on the first mobile device may include a database such as ‘sqlite’ which can be encrypted. The balance can be written as a row in the database with a date and time stamp. Other secure methods can be implemented to protect the SVA balance from unauthorized access or changes.

Next, as shown with line (11.2.1) the second mobile payment application registers with the proximity surround (11.3) using proximity UUID2 value and other registration data such as user name, account ID, picture, geo coordinates. The proximity surround (11.3) updates the surround database (11.4) with the proximity UUID2 value and other registration data. As shown in line (11.3.2) the proximity surround can then access the core system (11.5) to determine if the registered user has an associated stored value account (SVA). If the registered user has an associated SVA, the proximity surround can return the balance of the SVA to the mobile payment application comprised within registered the second registered mobile device (11.2). The mobile payment application within the second registered mobile device can securely store the SVA balance on the second mobile device (11.2) as shown in line (11.3.4). A secure storage method on the second mobile device may include a database such as ‘sqlite’ which can be encrypted. The balance can be written as a row in the database with a date and time stamp. Other secure methods can be implemented to protect the SVA balance from unauthorized access or changes.

Next, based on methods previously described in FIG. 8, the first registered mobile device can use the BLE antenna to advertise its proximity UUID1 value. This process is shown in line (11.1.2). Registered mobile device two is operable to listen for the BLE advertisement from the first registered mobile device using its BLE antenna. The second registered mobile device BLE antenna is operable to capture the BLE advertising signal and request the identity of the user. Using the UUID1 value transmitted from the first registered mobile device, the second mobile device requests the identity of the registered user from the proximity surround system. This request is illustrated using line (11.4.1). The user information is received from the proximity surround and is available for display on the second registered mobile device. This process is illustrated using line (11.3.5).

Next, the second registered mobile device can use the BLE antenna to advertise its proximity UUID2 value. This process is shown in line (11.2.3). Registered mobile device one is operable to listen for the BLE advertisement from the second registered mobile device using its BLE antenna. The first registered mobile device BLE antenna is operable to capture the BLE advertising signal and request the identity of the user. Using the UUID2 value transmitted from the second registered mobile device, the first mobile device requests the identity of the registered user from the proximity surround system. This request is illustrated using line (11.4.2). The user information is received from the proximity surround and is available for display on the second registered mobile device. This process is illustrated using line (11.3.6).

The user of the first registered mobile device (11.1), having now identified the user corresponding to the second registered mobile device (11.2) can initiate a payment using the mobile application comprised within the first registered mobile device and based on the value of the SVA account previously stored in the secure database comprised within the first registered mobile device. Line (11.1.4) illustrates the step whereby the application comprised within the first registered mobile device submits a payment request to the proximity surround system, request message including: UUID1 value, UUID2 value, payment amount and perishable token which is related to this payment request. In order to record the pending payment and to put a hold on the funds, the UUID2 value, payment request amount, payment amount and a date and time stamp can be written by the mobile application comprised within the first registered mobile device as a row in the secure database comprised within the first registered mobile device as shown in step (11.1.5). A column in the secure database is reserved by the mobile application for the purpose of maintaining a setting to facilitate holding the value of the funds to prevent the same funds from being used for another payment. It is important to note, that the SVA balance previously stored in the secure database comprised within the first registered mobile device is not updated during this step. Rather, the value associated with the pending payment is aggregated to the SVA balance in memory for display and functional purposes.

Now, as shown in line (11.1.6) the application comprised within the first registered mobile device can send a BLE message directly to the application comprised within the second mobile device as a notification of a pending payment. The message can include the UUID1 value, payment amount, perishable token, and a date and time stamp. As shown in step (11.2.3) the application comprised within the second registered mobile device can write a record to the secure database comprised within the second mobile device to record the UUID1 value, payment amount, perishable token and date and time stamp included within the BLE payment notification message received from the first registered mobile device. A column in the secure database is reserved by the mobile application for the purpose of maintaining a setting to facilitate use of the funds pending the official notification of payment from the proximity surround. Now, from this point, the application comprised within the second registered mobile device may include the value of the funds received in the BLE payment notification for its purposes, which may include display or payment. It is important to note, that the SVA balance previously stored in the secure database comprised within the second registered mobile device is not updated. Rather, the value associated with pending payment reflected in the BLE message (11.1.6) is aggregated to the SVA balance in memory for display and functional purposes.

As shown in line (11.4.3) the proximity surround (11.3) uses the UUID1 and UUID2 values to lookup the identity of the registered users in the surround database (11.4). Having now determined the identity of both users, the proximity surround system (11.4) is operable to perform an anti-money-laundering (AML) and know-your-customer (KYC) check. This process is shown using line (11.6.1). AML checks and KYC checks can be performed based on configuration settings to identify potential fraud and as a result of either check a transaction may be suspended pending further investigation. However, if the result of the AML and KYC check does not suspend the transaction, the proximity surround system (11.3) can update the SVA balances associated with the first registered user and the second registered user based on the payment amount.

Having now updated the SVA balances associated with the first registered user and the second registered user, the proximity surround (11.3) is operable to send a payment completion message to the first registered mobile device. The message can include the perishable token associated with the completed payment, payment amount, and updated SVA balance. This step is shown in line (11.3.6). At this point, the application comprised within the first registered mobile device can update the column comprised within the secure database indicating that the pending payment has been successfully completed. The new SVA balance associated with the first registered mobile device is written to the secure database along with a date and time stamp. Next, the proximity surround (11.3) is operable to send a payment completion message to the second registered mobile device. The message can include the perishable token associated with the completed payment, payment amount, and updated SVA balance. This step is shown in line (11.3.7). At this point, the application comprised within the second registered mobile device can update the column comprised within the secure database indicating that the pending payment has been successfully completed. The new SVA balance associated with the second registered mobile device is written to the secure database along with a date and time stamp.

It should be noted that steps (11.1.1, 11.3.2, 11.2.1, 11.3.5, 11.3.6 and 11.3.4) each implement connectivity between the registered mobile device and the remote proximity surround system (11.3). This connectivity may be in the form of one of a WiFi connection or a direct connection to a mobile network operator. At least in some cases, disruptions in the connectivity between the mobile application and the proximity surround may result in poor user experience and erroneous results. As such, the BLE messages and processes described in steps 11.1.5, 11.1.6, and 11.2.3 have been included. Should there be a temporary disruption in either the WiFi or the mobile carrier's network, payments may continue to be initiated between the registered users. However, in order to prevent fraud, velocity checks may be implemented and enforced by the mobile applications. For example, the mobile applications may be configured to allow no more than a certain number of pending payments without a payment acknowledgement message from the proximity surround. Or, the application may be configured to only allow pending payments to be used up to a pre-defined threshold for example.

In one embodiment, a method may be performed for conducting a transaction between registered users that are within a specified proximity of each other. The method includes receiving from a mobile device an identity request requesting the identity of a registered user, the request including an identifier of a first mobile device. The identifier may be a universally unique identifier (QUID) or some other type of device identifier. The method determines that the registered user has an associated stored value account (SVA). The SVA may be maintained by a central computing system or may be accessible to a service that facilitates transactions. Each registered user may have a SVA that stores some amount of value. The SVA itself may be linked to a credit account, a bank account or other types of accounts associated with the user. As such, the SVA may include a fixed amount of currency, credit or other forms of value that is determinable at any given time based on deposits to or withdrawals from the account.

The method may further include providing identity information associated with one registered user to another registered user. In cases where two user's mobile devices are determined to be in relative proximity to each other (see FIGS. 8 and 9 above), the devices may communicate using Low Energy Bluetooth (BLE) or using some other protocol or standard for wireless communication. The devices may communicate their current position and the Proximity Surround 8.4 may determine the current distance between the devices. When the devices are within a specified distance, they may conduct a transaction. This transaction involves determining the identity of each party (the payee and the payor). Accordingly, the Proximity Surround service (11.3 in FIG. 11) may receive from a first mobile device an identity request requesting the identity of the second registered user and may receive a request from the second mobile device requesting the identity of the first registered user at the first mobile device. Each request may include the QUID of the other user's device.

The Proximity Surround service may determine that each user is registered and has an associated SVA. The Proximity Surround service may further provide identity information associated with the second registered user to the first registered user and provide identity information associated with the first registered user to the second registered user. Still further, the Proximity Surround service may receive a payment request including the first mobile device's identifier, the second mobile device's identifier, a payment amount and a perishable token associated with the payment request. The Proximity Surround service may then update the first registered user's SVA to reflect an amount debited from the first registered user's SVA, update the second registered user's SVA to reflect an amount credited to the second registered user's SVA and send a payment receipt to the first registered user and to the second registered user indicating that the requested payment was processed.

The Proximity Surround 11.3 may further be configured to store UUID values and any determined distance values received from the registered mobile devices (11.1 and/or 11.2) in a data store such as the Surround Database 11.4 or in other local or remote data stores. In some cases, BLE transmitters may be configured to transmit UUID values as outgoing BLE advertisements or as part of outgoing BLE advertisements. For example, the UUID value for a given mobile device may be attached to standard BLE advertisements as metadata. In other embodiments, such as with Android devices, the Proximity Surround service 11.3 may receive a request for any new devices that are nearby but cannot transmit a signal for detection. If the Proximity Surround service has detected or is aware of any such devices that cannot transmit detection signals, the Proximity Surround service may answer such a request by providing the mobile device identifier (e.g. UUID) for those devices. In some cases, the Proximity Surround service may be configured to access the surround database 11.4 or other data store to determine the identity of a detected BLE UUID value including at least one other nearby “invisible” device (i.e. a device that cannot or does not transmit detection signals).

In some embodiments, the Proximity Surround service may be configured to determine that one mobile device is within an established proximity radius based on the current latitude and longitude of another mobile device prior to returning registered user information associated with the second mobile device. Thus, the service may reduce the chance of fraud by conducting transactions with those mobile devices that are within a specified radius of the user's mobile device, and further may conduct transactions with only those devices that are registered and/or whose users are registered. In this manner, two parties in close proximity may conduct a transaction with each other using secure, stored value accounts, knowing that each party is registered with the Proximity Surround service. In some cases, the Proximity Surround service may provide an indication to one party indicating whether the other party has sufficient funds in their SVA to complete a given transaction. This ensures that the payee will be paid by the payor. Then, once the transaction is completed, a receipt may be sent to each party to notify them that the transaction has succeeded, and that the money or other value was transferred from one registered user's account to another's.

In some embodiments, one of the registered users may be a device such as a vending machine or turnstile. These devices may not be configured with persistent wireless (e.g. WiFi or cellular) connectivity, but can be operable to transmit and receive QUID values and accept and record payments from other registered users.

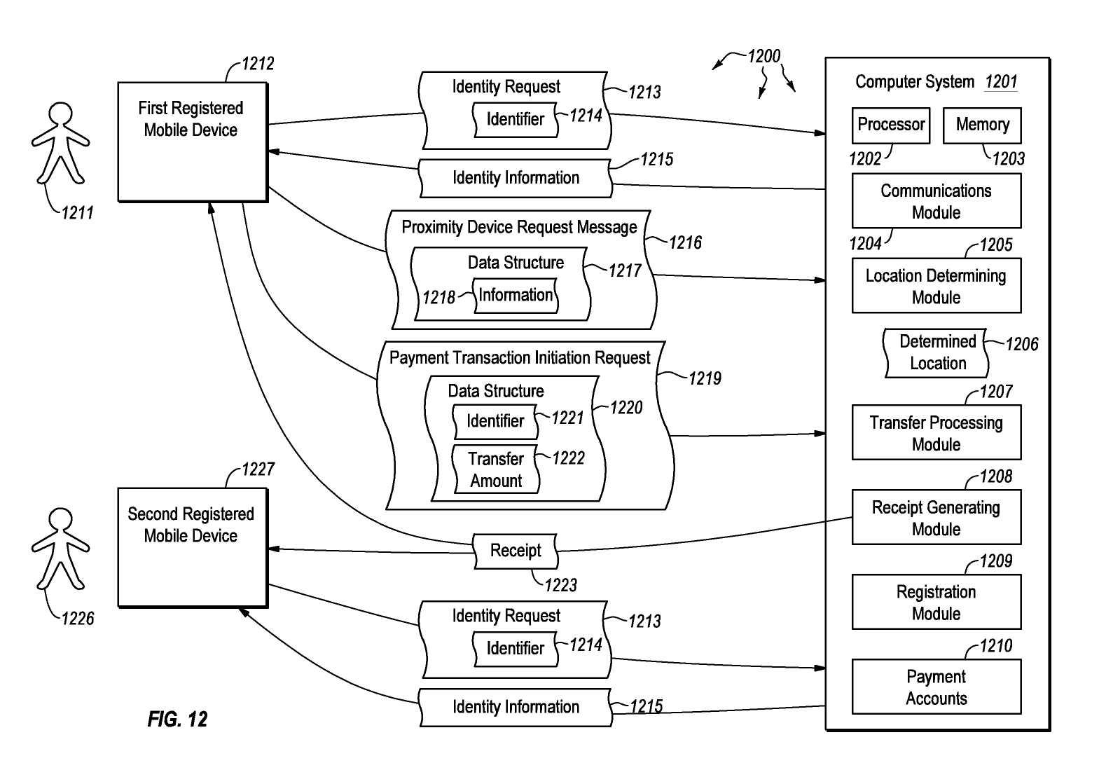

FIG. 12 illustrates a computer architecture 1200 in which at least one embodiment may be employed. Computer architecture 1200 includes computer system 1201. Computer system 1201 may be any type of local or distributed computer system, including a cloud computing system. The computer system includes a hardware processor 1202 and hardware memory 1203. The computer system 1201 also includes modules for performing a variety of different functions. For instance, the communications module 1204 may be configured to communicate with other computing systems. The communications module 1204 may include any wired or wireless communication means that can receive and/or transmit data to or from other computing systems. The communications module 1204 may be configured to interact with databases, mobile computing devices (such as mobile phones or tablets), embedded or other types of computing systems.

The communications module 1204 may, for example, be configured to communicate with mobile devices such as first registered mobile device 1212 and second registered mobile device 1227. The mobile devices may send various communications such as identity requests or proximity device request messages to the computer system 1201 which are received by the communications module 1204. Once proper reply messages are generated, they may be communicated back to the first and second mobile devices 1212 and 1227, respectively, using any wired or wireless communication means. The messages and requests of FIG. 12 may be transferred between the mobile devices and the computer system 1201 during the processing of a transaction between the first and second mobile devices, or rather between the first and second mobile device users 1211 and 1226.

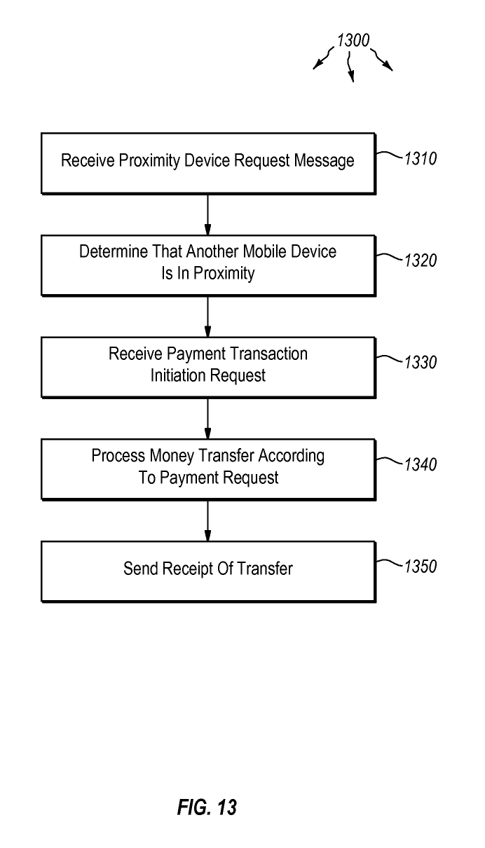

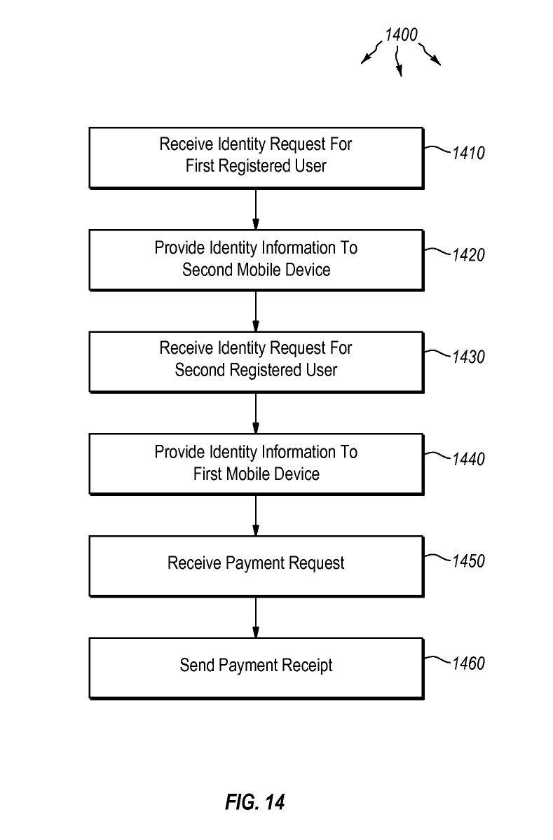

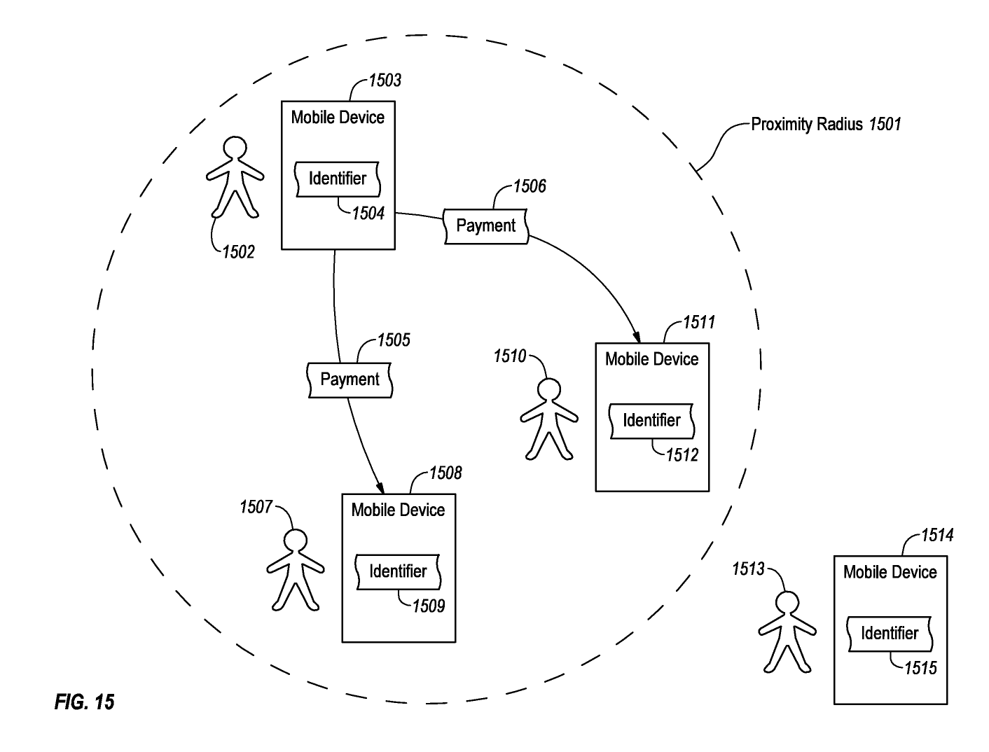

In some embodiments, for example, the first user 1211 may desire to transfer money to the second user 1226. This money transfer may be a payment for a good or service, it may be a tip for services performed, it may be a gift from one user to another or may be money transferred for any reason. The money may be transferred to a user that is within a specified proximity of another user. Thus, as will be shown further in FIG. 15, various steps may be performed to determine which mobile devices are within a specified distance from a user. Once the appropriate device is determined, the money transfer may be completed. Thus, for example, if a user wanted to give a tip to a doorman, the user's phone may determine that the doorman (and possibly other users) has a mobile device within the area around the user. The embodiments described herein are configured to distinguish the doorman's mobile device from any other devices in the user's area and transfer a payment (in this case, a tip) to the doorman's mobile device. This and other embodiments will be described further below with regard to methods 1300 and 1400 of FIGS. 13 and 14, respectively.

In view of the systems and architectures described above, methodologies that may be implemented in accordance with the disclosed subject matter will be better appreciated with reference to the flow charts of FIGS. 13 and 14. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 12 illustrates a flowchart of a method 1300 for identifying mobile devices within a specified proximity. The method 1300 will now be described with frequent reference to the components and data of environment 1200 of FIG. 12.

Method 1300 includes receiving from a first registered mobile device a proximity device request message, the proximity device request message comprising a data structure that includes information requesting identification of mobile devices within a specified range of the first mobile device (1310). For example, the communications module 1204 of computer system 1201 may receive proximity device request message 1216 from the first registered mobile device 1212. The mobile device may have previously registered with the computer system 1201. Indeed, prior to receiving the proximity device request message 1216, the communications module 1204 may have received from the first mobile device a registration message that includes a data structure that itself includes one or more of the following corresponding to the first mobile device: current geographic coordinates of the first mobile device 1212, a user identifier identifying the user 1211 of the first mobile device, a package universally unique identifier (pUUID) associated with the first mobile device, a major identifier and/or a minor identifier.

The communications module 1204 may have also received similar information in a second registration message from the second mobile device. The registration message may include a data structure that itself includes one or more of the following corresponding to the second mobile device 1227: geographic coordinates of the second mobile device, a user identifier identifying the user 1226 of the second mobile device, a pUUID for the second mobile device, a major identifier and/or a minor identifier. Using this information, the first and second mobile devices (1212 and 1227) and/or their users (1211 and 1226) may be registered with the computer system 1201. The registration module 1209 may store the registration data in a database, and may associate the device user with the device, such that actions performed by the device are said to be performed by the user, and vice versa. The registration allows the computer system to find other registered users that are near the first user. The proximity device request message 1216 send out by the first registered mobile device requests identification of mobile devices within a specified range of the first mobile device. This request is included in information 1218 contained in a data structure 1217 that is sent with the proximity device request message 1216.

Upon receiving such a proximity device request message 1216, the location determining module 1205 of computer system 1201 determines that a second registered mobile device is currently in a location that falls within the specified range of the first mobile device (1320). The specified range surrounding the first mobile device may, in some cases, be a specified distance in any direction from the first mobile device's current location. The distance may be arbitrarily chosen, may be chosen by the device's user, may be chosen by an application or operating system programmer or some other user and may be adjustable or fixed. The shape of the specified range may be circular, square or some other shape. Indeed, the specified range may include any device that is close enough to receive a signal from the device such as a BLE signal.

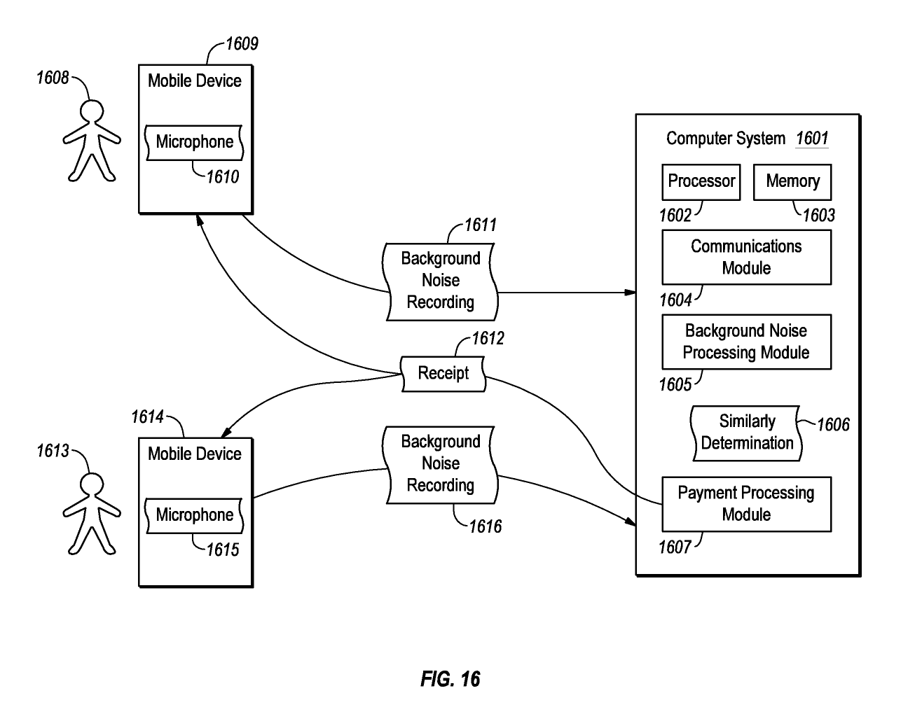

The location determining module 1205 may determine the second registered mobile device's location in a number of different ways. For example, the location determining module 1205 may receive location information directly from the second mobile device itself. This may include GPS data such as latitude and longitude, map data, Wifi-based triangulation data or cell tower data or any other data usable to locate the device. In some cases, as shown in FIG. 16, background noise may be used to determine that two (or more) devices are within a given proximity.

FIG. 16 illustrates two users 1608 and 1613, each with their own mobile device 1609 and 1614, respectively. Each mobile device has a microphone (1610/1615) that is capable of recording external sounds. Each mobile device may transfer background noise recordings 1611/1616 to the computer system 1601. As with computer system 1201, computer system 1601 may be any type of local or distributed computing system and may be a cloud computing system. The computer system 1601 includes at least one hardware processor 1602 or processing core and a hardware memory 1603. The computer system 1601 also includes a communications module 1604 which may be configured to receive the background noise recordings 1611 and 1616.

The background noise processing module 1605 may analyze the two (or more) background noise recordings to determine whether they are sufficiently similar. Indeed, if the two recordings are taken at substantially the same time and are similar enough (that is, they share distinct tonal, frequency or cadence components), then the background noise processing module can determine that the two (or more) devices are in the same general location. The recordings may be long or short, and in some cases, may be very short. Indeed, some locations (such as downtown locations) may include sounds of cars, people talking, sirens, doors opening and closing or other sounds. Each of these sounds may be analyzed and noted. Then, if another user is in the same area, each noted sound may be compared to those found in the other user's background noise recording. If a sufficient number of specified sounds or tones or cadences are found in both recordings, then the two are said to be matched and are identified as being located in the same proximity. The similarity determination 1606 will then indicate that the background noise recordings are either sufficiently similar to be in the same general proximity, or if not, that the recordings are not sufficiently similar and the devices are most likely not in the same general proximity.

Method 1300 next includes receiving from the first mobile device a payment transaction initiation request requesting that money be transferred from the first mobile device to the second mobile device, the payment transaction initiation request comprising a data structure that includes at least one identifier corresponding to the first mobile device and a transfer amount (1330). Once the first and second mobile devices are determined to be in the same proximity, whether based on a BLE communication between the devices, based on a background noise comparison, based on a projected noise, based on similar GPS coordinates, or based on some other location determination, the first mobile device 1212 may send a payment transaction initiation request 1219 to the computer system 1201. The payment transaction initiation request 1219 includes a data structure 1220 with an identifier 1221 of the first mobile device and an amount of money that is to be transferred (i.e. transfer amount 1222). The identifier 1221 may be a device name, a user name, an account identifier or any other identifier associated with the first mobile device 1212. The transfer processing module 1207 of computer system 1201 then processes the money transfer according to the payment transaction initiation request 1219 such that the transfer amount 1222 is transferred from the first mobile device 1212 to the second mobile device 1226 (1340). Upon completion of the transfer, the receipt generating module 1208 generates an electronic receipt 1223 indicating that the transfer amount was transferred to the second mobile device (1350). This receipt is then sent to the first and/or second mobile devices.

In some embodiments, the first mobile device's current location may be identified by major x and minor x coordinate values. These may be, for example, longitude and latitude values given by a GPS radio or supplied by a GPS application. Alternatively, the major x and minor x coordinate values may be determined based on the mobile device's other radio connections such as Bluetooth, Wifi, code division multiple access (CDMA), global system for mobiles (GSM) or other wireless signals.

In some cases, the devices' locations may be determined by transmitting recorded sound wave messages to each other and then broadcasting those same sound waves. For example, the second registered mobile device 1227 may send a recorded sound which could be any recorded sound including a song, a voice, a single frequency tone or any other recorded sound. In some cases, the recorded sound may be inaudible to human ears. The recording or other sound waves may be sent as a message to the first registered mobile device 1212. The first mobile device may then be configured to play that sound. If the tone is inaudible to humans, no person would notice that the sound was being played; however, the second mobile device 1227 would be able to detect that the sound was being played back, and would know that the first mobile device is within its proximity. Thus, the sound wave may be broadcast from the first mobile device and received by the second mobile device, and then in some cases, may be sent to the computer system 1201. In this manner, a recorded sound wave message may be used to determine that the second registered mobile device is currently in a location that is within the specified range of the first mobile device 1212.

In some embodiments, when the requested transaction between the first and second mobile devices is being carried out, the computer system 1201 may indicate to the second registered mobile device 1227 that the first registered mobile device 1212 has sufficient funds to complete the transfer. This indication may provide assurance to the user 1226 of the second mobile device that the first user 1211 can cover the purchase amount and that the transaction will be approved. The first mobile device 1212 may be configured to provide a secure database (or provide a communication path to a secure database) that holds the value of the transfer amount. This prevents the value of the transfer amount from being used for another transfer. In such cases, the payment transaction initiation request 1219 may be initiated using a mobile application on the first registered mobile device 1212 based on the value of the payment account stored in the secure database of the first registered mobile device. The application on the first registered mobile device may be configured to update the secure database of the first mobile device indicating that the pending payment has been successfully completed. Then, a new transfer balance associated with the first registered mobile device is written to the secure database along with a date and time stamp.

In connection with recording the pending payment and holding the value of the payment amount, the second mobile device's QUID, the payment request amount, and a date and time stamp may be written by the mobile application on the first registered mobile device as a row in the secure database of the first registered mobile device. The application on the second registered mobile device 1227 may further be configured to update a secure database on the second mobile device indicating that the pending payment has been successfully completed. In such cases, the new transfer balance associated with the second registered mobile device is written to the secure database of the second mobile device along with a date and time stamp. In this manner, each mobile device may track the occurrence of payments and transfers in a secure database, and thereby ensure that all fund transfers are accounted for and recorded.

Turning now to FIG. 14, a flowchart is illustrated of a method 1400 for conducting a transaction between registered users that are within a specified proximity of each other. The method 1400 will now be described with frequent reference to the components and data of environment 1200 of FIG. 12.

Method 1400 includes receiving from a second mobile device an identity request requesting the identity of a first registered user, the first registered user having an associated payment account, the identity request including an identifier of a first mobile device associated with the first registered user (1410). For example, the communications module 1204 of computer system 1201 may receive from the second mobile device 1227 an identity request 1224 that requests the identity of a first registered user (e.g. 1211). The first registered user has a payment account 1210 which may be stored in computer system 1201 or in another (perhaps remote) computing system. The identity request includes identifier 1228 which is an identifier of the first mobile device 1212 associated with the first registered user 1211. The identifier may be a user name, a hardware identifier of the first mobile device or other type of unique identifier. In some cases, this identifier is provided by the first mobile device to the second mobile device once the devices are within a given proximity. Thus, upon receiving such an identifier, the second mobile device may send the identifier 1228 along with an identity request to determine the identity of the user 1211 associated with the first mobile device 1212.

Upon determining that the first mobile device is within an established proximity radius, the computer system 1201 may provide at least a portion of identity information associated with the first registered user 1211 to the second mobile device 1227 (1420). As shown in FIG. 15, a proximity radius 1501 may be established using beacons, or may simply be the extent to which a mobile device can transmit wireless signals to other mobile devices around it. Thus, for instance, user 1502 may wish to use their mobile device 1503 (e.g. a smartphone) to initiate a payment between user 1507 and user 1510. Each mobile device has an identifier (1504 for device 1503, 1509 for device 1508, and 1512 for device 1511. This identifier may be sent to the computer system 1201 of FIG. 12 to determine which user is registered to that mobile device. Once identities have been established and payment accounts (e.g. credit accounts, bank accounts, or other stored value accounts such as electronic currencies) have been verified, payments 1505 and 1506 may be made from user 1502 to users 1507 and 1510, respectively.

Returning to FIG. 14, method 1400 further includes receiving from the first mobile device an identity request requesting the identity of the second registered user, the second registered user having an associated payment account, the identity request including an identifier of the second mobile device associated with the second registered user (1430). Thus, as with the second mobile device above, the first mobile device 1212 may also send an identity request 1213 including identifier 1214 (which identifies the second mobile device 1227) to the computer system 1201. Upon determining that the second mobile device 1227 is within an established proximity radius, the computer system 1201 may provide identity information 1215 associated with the second registered user 1226 to the first mobile device 1212 (1440). This identity information 1215 may be encrypted between the computer system 1201 and the first and second mobile devices, thereby increasing data transmission security.

Method 1400 next includes receiving a payment request 1219 including the first mobile device's identifier 1228, the second mobile device's identifier 1215, a payment amount 1222 and a perishable token associated with the payment request (1450). Then, after the first registered user's payment account 1210 has been updated to reflect an amount debited from the first registered user's payment account and after updating the second registered user's payment account 1210 has been updated to reflect an amount credited to the second registered user's payment account, the communications module 1204 may send a payment receipt 1223 to the first mobile device and to the second mobile device indicating that the requested payment was processed (1460). As each user's payment account information is not actually transferred between users, and is instead only transferred to the computer system 1201, security of the payment process is increased. Moreover, as this payment account data is not transferred between the user's mobile devices, wireless network bandwidth is conserved during the payment process.

In some embodiments, Bluetooth low energy (BLE) transmitters may be configured to transmit universally unique identifier (UUID) values as outgoing BLE advertisements. These BLE advertisements may be used to determine that the first and second mobile devices are within the established proximity radius. Indeed, as mobile devices respond to the BLE advertisements (which are limited in transmission distance due to their low transmission power), the transmitter of the BLE advertisements may determine who is responding by looking up registered users that have identifiers matching those of the responding device. In some cases, a data store such as a distributed database may be accessed to determine the identity of a detected BLE UUID value (e.g. identifier 1214 or 1228). The data store may also be used to identify other nearby devices by providing access to those devices' registration information which links registered devices to registered users. These UUID values and proximity values for the first and second mobile devices may be stored in a data store such as a distributed database, or may be stored locally.

In this manner, different embodiments are provided which enable a computing system to identify mobile devices within a specified proximity. Moreover, embodiments allow a computing system to conduct a transaction between registered users that are within a specified proximity of each other. It should be noted that various modifications and changes may be made without departing from the spirit and scope of the present invention. Consequently, these and other modifications are contemplated to be within the spirit and scope of the following claims.

We claim:

1. At a computer system including at least one processor, a computer-implemented method for identifying mobile devices within a specified proximity, the method comprising:
receiving from a first registered mobile device a proximity device request message, the proximity device request message comprising a data structure that includes information requesting identification of mobile devices within a specified range of the first mobile device;
determining that a second registered mobile device is currently in a location that falls within the specified range of the first mobile device;
receiving from the first mobile device a payment transaction initiation request requesting that money be transferred from the first mobile device to the second mobile device, the payment transaction initiation request comprising a data structure that includes at least one identifier corresponding to the first mobile device and a transfer amount;
processing the money transfer according to the payment transaction initiation request such that the transfer amount is transferred from the first mobile device to the second mobile device; and
sending a receipt to the first mobile device indicating that the transfer amount was transferred to the second mobile device.

2. The method of claim 1, further comprising receiving from the first mobile device a first registration message, the first registration message comprising a data structure that includes one or more of the following corresponding to the first mobile device: current geographic coordinates, a user identifier identifying the user of the first mobile device, a package universally unique identifier (pUUID) associated with the first mobile device, a major identifier and a minor identifier; and
receiving from the second mobile device a second registration message, the second registration message comprising a data structure that includes one or more of the following corresponding to the second mobile device: geo coordinates, a user identifier identifying the user of the second mobile device, a pUUID, a major identifier and a minor identifier.

3. The method of claim 1, wherein the specified range surrounding the first mobile device comprises a specified distance in any direction from the first mobile device's current location.

4. The method of claim 1, wherein the first mobile device's current location is identified by major x and minor x coordinate values.

5. The method of claim 1, wherein the at least one identifier included in the payment transaction initiation request comprises a device name, a user name or an account identifier associated with the first mobile device.

6. The method of claim 1, further comprising:
transmitting to the first mobile device a recorded sound wave message to be broadcast from the first mobile device; and
receiving from the second mobile device a recording of the same sound wave message broadcast from the first mobile device to the second mobile device.

7. The method of claim 6, wherein the recorded sound wave message is used to determine that the second registered mobile device is currently in a location that is within the specified range of the first mobile device.

8. The method of claim 1, further comprising:
receiving from the first mobile device a data structure that includes at least a portion of background noise from the first mobile device's current location;
receiving from the second mobile device a data structure that includes at least a portion of background noise from the second mobile device's current location; and
wherein determining that the second registered mobile device is currently in a location that is within the specified range of the first mobile device comprises determining that the portion of background noise received from the second mobile device is sufficiently similar to the portion of background noise received from the first mobile device.

9. A computer system comprising the following:
one or more processors;
system memory;
one or more computer-readable storage media having stored thereon computer-executable instructions that, when executed by the one or more processors, cause the computing system to perform a method for conducting a transaction between registered users that are within a specified proximity of each other, the method comprising the following:
receiving from a second mobile device an identity request requesting the identity of a first registered user, the first registered user having an associated payment account, the identity request including an identifier of a first mobile device associated with the first registered user;
upon determining that the first mobile device is within an established proximity radius, providing at least a portion of identity information associated with the first registered user to the second mobile device;
receiving from the first mobile device an identity request requesting the identity of the second registered user, the second registered user having an associated payment account, the identity request including an identifier of the second mobile device associated with the second registered user;
upon determining that the second mobile device is within an established proximity radius, providing at least a portion of identity information associated with the second registered user to the first mobile device;
receiving a payment request including the first mobile device's identifier, the second mobile device's identifier, a payment amount and a perishable token associated with the payment request; and
upon updating the first registered user's payment account to reflect an amount debited from the first registered user's payment account and upon updating the second registered user's payment account to reflect an amount credited to the second registered user's payment account, sending a payment receipt to the first mobile device and to the second mobile device indicating that the requested payment was processed.

10. The computer system of claim 9, wherein Bluetooth low energy (BLE) transmitters are configured to transmit UUID values as outgoing BLE advertisements, the BLE advertisements being used to determine that the first and second mobile devices are within the established proximity radius.

11. The computer system of claim 10, further comprising storing the UUID values and proximity values for the first and second mobile devices in a data store.

12. The computer system of claim 11, further comprising accessing a data store to determine the identity of a detected BLE UUID value including at least one other nearby invisible device.

13. The computer system of claim 9, wherein determining that the first and second mobile devices are within the established proximity radius is based on the current latitude and longitude of the first and second mobile devices.

14. A computer program product for implementing a method for identifying mobile device users within a specified proximity, the computer program product comprising one or more computer-readable storage media having stored thereon computer-executable instructions that, when executed by one or more processors of the computing system, cause the computing system to perform the method, the method comprising:
receiving from a first registered mobile device a proximity device request message, the proximity device request message comprising a data structure that includes information requesting identification of mobile devices within a specified range of the first mobile device;
determining that a second registered mobile device is currently in a location that falls within the specified range of the first mobile device;
receiving from the first mobile device a payment transaction initiation request requesting that money be transferred from the first mobile device to the second mobile device, the payment transaction initiation request comprising a data structure that includes at least one identifier corresponding to the first mobile device and a transfer amount;
processing the money transfer according to the payment transaction initiation request such that the transfer amount is transferred from the first mobile device to the second mobile device; and
sending a receipt to the first mobile device indicating that the transfer amount was transferred to the second mobile device.

15. The computer program product of claim 14, further comprising indicating to the second registered mobile device that the first registered mobile device has sufficient funds to complete the transfer.

16. The computer program product of claim 14, wherein the first mobile device includes a secure database that holds the value of the transfer amount to prevent the value of the transfer amount from being used for another transfer.

17. The computer program product of claim 16, wherein the payment request is initiated using a mobile application on the first registered mobile device based on the value of the payment account stored in the secure database of the first registered mobile device.

18. The computer program product of claim 16, wherein in connection with recording the pending payment and holding the value of the payment amount, the second mobile device's QUID, the payment request amount, and a date and time stamp are written by the mobile application on the first registered mobile device as a row in the secure database of the first registered mobile device.

19. The computer program product of claim 16, wherein the application on the first registered mobile device updates the secure database of the first mobile device indicating that the pending payment has been successfully completed, and wherein a new transfer balance associated with the first registered mobile device is written to the secure database along with a date and time stamp.

20. The computer program product of claim 16, wherein the application on the second registered mobile device updates the secure database of the second mobile device indicating that the pending payment has been successfully completed, and wherein the new transfer balance associated with the second registered mobile device is written to the secure database along with a date and time stamp.
